(19) United States
(12) Patent Application Publication
(10) Pub. No.: US 2008/0132205 A1
(43) Pub. Date: Jun. 5, 2008

(54) Method and System for Device Identity Check

(76) Inventor: Britt-Mari Svensson, Sollentuna (SE)

Correspondence Address: FASTH LAW OFFICES (ROLF FASTH), 26 PINECREST PLAZA, SUITE 2, SOUTHERN PINES, NC, 28387-4301, US

(21) Appl. No.: 11/574,356

(22) PCT Filed: Aug. 22, 2005
(86) PCT No.: PCT/SE05/01229

§ 371 Date: Jul. 31, 2007

(30) Foreign Application Priority Data
Aug. 31, 2004 (SE) 0402105-1

(51) Int. Cl. H04M 1/66

(52) U.S. Cl. 455/411

(57) ABSTRACT

The method is for checking an identity of devices in a device management system in a mobile telecommunication network. The system has devices to be managed, a server-side device management application, a client-side device management application, databases, and an interface between the device management applications. The server-side device management application initiates a device management session via the interface. The interface sends a query to the client-side device management application. The client-side device management application reads equipment information and sends it to the interface. The interface compares the equipment information sent with previously stored equipment information for the subscription from which the equipment information was sent and reports the comparison result to the server-side device management application.

### TECHNICAL FIELD

The invention is concerned with a method and system for checking the identity of devices in a device management system in a mobile telecommunication network, the system comprising devices to be managed, a server side device management application, a client side device management application and databases, and an interface between said device management applications,

### BACKGROUND

GSM, together with other technologies, is part of an evolution of wireless mobile telecommunication. The Global System for Mobile Communication (GSM) is a standard for digital wireless communications with different services, such as voice telephony. The Subscriber Identity Module (SIM) inside GSM phones was originally designed as a secure way to connect individual subscribers to the network but is nowadays becoming a standardized and secure application platform for GSM and next generation networks.

The Mobile Station (MS) represents the only equipment the GSM user ever sees from the whole system. It actually consists of two distinct entities. The actual hardware is the Mobile Equipment (ME), which consists of the physical equipment, such as the radio transceiver, display and digital signal processors. The subscriber information is stored in the Subscriber Identity Module (SIM), implemented as a Smart Card.

With respect to the terminology used in this document, The Mobile Station (MS) includes the Mobile Equipment (ME) and the Subscriber Identity Module (SIM). The term “Handset” is used as a synonym to the Mobile Equipment (ME) and the term “Device” as a synonym to The Mobile Station (MS).

The mobile equipment is uniquely identified by the International Mobile Equipment Identity (IMEI) being a unique code that corresponds to a specific GSM handset while the SIM card, in turn, is identified by the Integrated Circuit Card Identity (ICCID) determining the serial number of the card, and contains the International Mobile Subscriber Identity (IMSI), identifying the subscriber, a secret key for authentication, and other user information. The IMEI and the IMSI or MSISDN are independent and can thereby provide personal mobility.

The Mobile Station Integrated Service Digital Network Number, MSISDN, is the standard international telephone number used to identify a given subscriber. The operator declares the subscription in a database inside the network, which holds the correspondence between the IMSI and the MSISDN. By inserting the SIM card into another GSM terminal, the user is able to receive and make calls from that terminal, and receive other subscribed services.

Advanced mobile services such as browsing, multimedia messaging, mobile e-mail, and device management can only be used if a mobile phone is configured correctly. However, many customers do not know how to configure their device. Operators must ensure that device configuration is quick and easy for the customer. This process of managing device settings and applications is called device management.

A device management session includes e.g. authentication (user verification), device inventory (a device management application read which parameters and applications are installed in the telephone for future decisions, such as e.g. updating, adding and deleting things from the installations), continuous provisioning (a device management application e.g. updates parameters on the telephone device, sends applications to the device, performs software and firmware updates), device diagnostics (error finding), etc.

Sending new settings over the air is one simple way to provision a device with configuration parameters, such as connectivity information (device settings). After receiving the settings to configure the phone, the customer simply saves them to the phone and is then able to use the services. For the operator, simplifying access to advanced services can bring higher usage rates, new revenue streams, and reduced customer helpline costs.

When a mobile terminal attaches to the network, it sends a signal to the network containing both IMSI end IMEI information. The Swedish patent applications 0302626-7 and 0303210-9 of the applicant present improved solutions for introducing a new terminal or SIM to the network.

As a result of technological development, networked and mobile/wireless devices are becoming more and more complex, and consequently, connected devices are also becoming more and more difficult to manage. Consumers and operators therefore need a tool for managing devices conveniently and effectively.

Device management is the generic term used for technology that allows third parties to carry out the difficult procedures of configuring mobile devices on behalf of the end users. There are numerous cases, wherein device management is needed such as new device purchase, remote service management, software download, changing and adding services, and service discovery and provisioning etc.

SyncML Device Management (SyncML DM) enables management of devices and applications, simplifying configuration, updates and support. Sponsored and supported by leading wireless companies, the SyncML initiative accelerates the development and market success of SyncML DS and SyncML DM technologies.

SyncML Device Management Protocol (SyncML DM) is thus a standard for communication between devices and device management server systems. The standardization body is OMA, Open Mobile Alliance. The device to be managed is equipped with a SyncML user agent in the device (i.e. terminal or handset) that speaks the SyncML DM language.

Device management applications are typically used by mobile service providers. They are used for customer care purposes and to increase revenue by effective value added service management. Example use-cases involve service- and settings provisioning, device diagnostics, statistics, firmware upgrade and software upgrade.

As the mobile device often consists of two entities—the Subscriber Identity Module (SIM) and the terminal equipment—in a device management environment both entities that make up the “device” are of interest. Both those entities need to be subjects of device management operations. A mobile service provider that wishes to do device management over e.g. SyncML DM is in fact using both handset residing and SIM residing content. That means, both equipment and subscription information are taken into account.

For this purpose, the device management application thus has to be aware of certain information of the devices that are supposed to be managed. The device management application has to be informed of the identity, address or phone number of the device, which information has been received in some way.

Usually, the device management application just has waited until a subscriber has decided to initiate a session and do self-management. The Swedish patent application 0401242-3 of the applicant presents improved solutions for device discovery.

Assuming a subscription centric device management environment, devices to be managed are kept track of by a subscription identity, like the IMSI, MSISDN or ICCID. A mobile service provider bases everything, like charging of the subscriber, on the subscription identity. A subscription identity is represented by a destination address where OTA addressing is concerned.

Seen from the subscription centric point-of-view, it is a subscription (i.e. the destination address) that operates in a handset (equipment), and that handset may change. In a subscription centric environment, the device management application might not know the relevant handset type used, and would need to retrieve that information from somewhere.

Assuming a handset centric device management environment, in turn, devices to be managed are kept track of by the identity of the individual handset equipment. This seems the natural thing to do, when considering all settings and applications that reside in an individual handset.

Seen from the handset centric point-of-view, it is the handset that suddenly can not be reached any longer, when an end user decides to switch to another subscription. A very probable situation is an end-user with one corporate- and one private subscription, which might use even different mobile service providers.

Problems arise when the subscriber changes to another handset or another subscription even if a device or subscription might have been known at subscription- and/or handset point-of-sale. Then the device management application can be left with an inaccurate combination of handset identity and subscription identity, such as the destination address as in a unified device management environment a “device” consists of two entities and does actually exist only in real-time.

This fact imposes said problems for both UDM and DM device management applications managing only handsets and not the SIM. In a handset centric environment, the mobile service provider cannot know the destination address for sure. He can only know what the destination address was at the last session. That implies that all server initiated management sessions are successful only by chance.

The SyncML DM device management application in turn cannot access a handset without the correct destination address. SyncML DM device management applications can either not perform a check of the UDM device identity, since it cannot speak SIM file management protocols.

In an UDM environment, devices have a composite identity consisting of both handset identifier and subscription identifier. The composite identity is referred to as the UDM Identity in this document forward.

If an end-user might has altered the combination since the last device management session took place, the UDM application would have an inaccurate UDM device identity. Hence the targeted handset can not be reach via this subscription. The targeted subscriber (subscription) is no longer using the same handset.

One solution for the device management application to be up to date with the current situation is to perform continuous device discovery in accordance with said Swedish patent application 0401242-3 of the applicant, which presents improved solutions for device discovery.

### OBJECT OF THE INVENTION

The object of the invention is to find new solutions to face the problem with altered UDM device identities.

### SUMMARY OF THE INVENTION

The method of the invention is for checking the identity of devices in a device management system is performed in a mobile telecommunication network comprising devices to be managed, a server side device management application, a client side device management application a databases, and an interface between said device management applications. In the steps of the method, the server side device management application initiates a device management session via said interface. The interface sends a query to said client side device management application. Said client side device management application reads equipment information and sends it to the interface. The interface compares the equipment information sent with previously stored equipment information for the subscription from which the equipment information was sent by means of subscription information for said subscription and reports said comparison result to the server side device management application.

The system of the invention comprises a component on the client side for reading the equipment identity, an interface for checking identity of devices from a device identity repository, and a database implementing a device identity repository.

The preferable embodiments of the method of the invention are presented in the subclaims.

In this document, a system that is concerned with both the handset and the SIM card is referred to as a Unified Device Management system (UDM).

The handset identifier and the subscription identifier can each be defined by several parameters. E.g. in the GSM environment, relevant as subscription identifiers are the subscription identity, the destination address, and/or the SIM card identity [IMSI, MSIDN, ICCID]. In this document the term “Subscription identifier” represents schematically all varieties of parameters for a subscription. The equipment identifier is defined by the IMEI. Consequently, the UDM Identity is a composite device identity that then consists of both the handset identifier and some variety of the subscription identifier. A fact is therefore that, in the UDM environment, the device identity actually only exists momentarily.

The invention includes a mechanism to perform a check of the UDM Device Identity. This is preferably achieved by an innovative merging of SIM file management technology and SyncML DM technology in the UDM environment. The UDM Device Identity Check makes sure that a device management application can operate efficiently with accurate (almost) real-time valid device identities.

Thus, the invention makes use of the fact that the device can be identified (and addressed) by the UDM device identity as described above. An end-user might have altered the combination since the last device management session took place. That would leave the UDM application with an inaccurate UDM device identity. Hence the targeted handset could not be reach via this subscription. The targeted subscriber (subscription) is no longer using the same handset. The invention successfully solves this problem by performing a UDM Device Identity Check before a device management session proceeds.

The solution of the invention is advantageously implemented by a device management application on the SIM card and a server side part implementing the communication and checking functions.

The checking of the UDM device identity is done via an on-SIM device management application, for example a browser application. The browser application takes care of reading the handset identity and returning of the value. Thus the checking is performed in real-time over-the-air. For example if the subscription is not active in the network at the moment, it would be revealed at the check.

An advantage of the invention is that it can be performed in a multi-subscription environment. A scenario with multi-subscription handsets and generally handsets with two or more SIMs and subscriptions needs a variety of UDM identities. In such a scenario the invention can fill the arising need for a check of real-time device identities.

In the following, the invention is described by means of some advantageous embodiments by referring to the figures. The intention is not to restrict the invention to the details of the following description. Thus, the device management application on the SIM card (or e.g. on an USIM card) can be of optional kind, such as e.g. a wireless browser application, the signaling can be implemented in an other environment than the GSM and use a bearer independent protocol.

### FIGURES

FIG. 1 is a view of a prior art target environment without the invention

FIG. 2 is a view of an environment that includes the entities that implements the method of the invention

FIG. 3 is a signal diagram of the method of the invention

### DETAILED DESCRIPTION

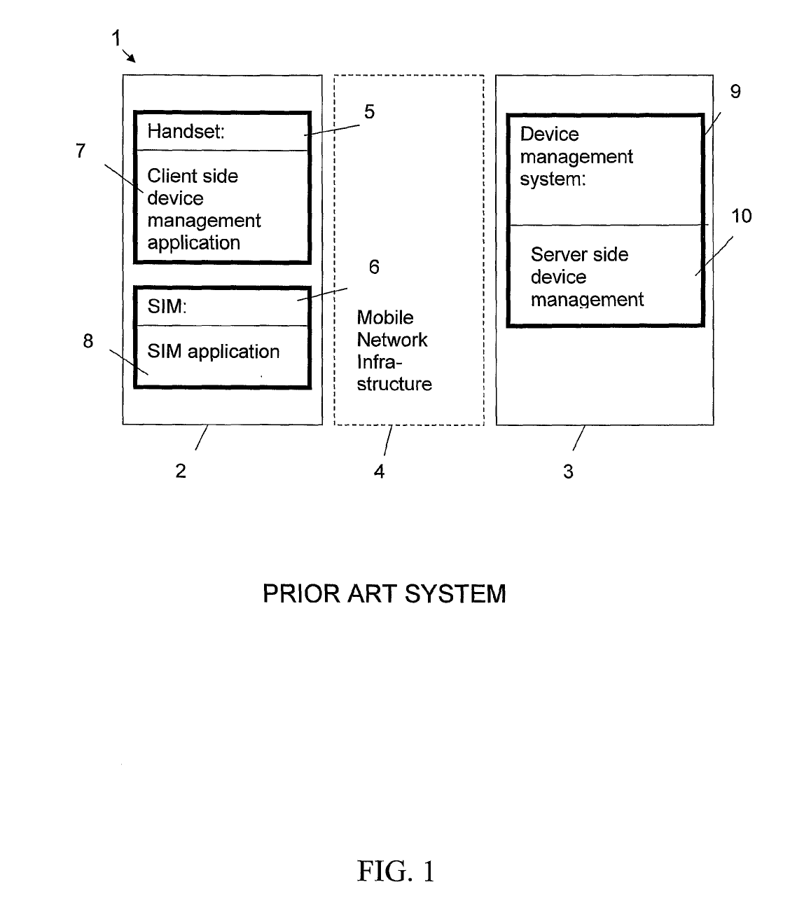

FIG. 1 is a view of a prior art target environment without the invention. The target environment is presented as an example of a telecommunication network 1 in which the invention can be used. The telecommunication network 1 comprises one or more devices to be managed, of which one device 2 and a device management server 3 can be seen in FIG. 1. The device 2 to be managed is in this example a mobile device 2 belonging to the mobile network infrastructure 4.

The Mobile Station (MS) (=the device) represents the only equipment the GSM user ever sees from the whole system. It actually consists of two distinct entities. The actual hardware is the Mobile Equipment (ME) (=handset) marked with reference number 5 in FIG. 1, which consists of the physical equipment, such as the radio transceiver, display and digital signal processors. The subscription information is stored in the Subscriber Identity Module (SIM), marked with reference number 6 in FIG. 1, implemented as a Smart Card.

In this context, mobile network infrastructure includes all components and functions needed for mobile data communication, both GSM and internet included. The mobile device, in turn, includes both the handset 5 and the SIM card 6. Thus, the mobile device 2 has access to the mobile network infrastructure 4.

SyncML Device Management Protocol (SyncML DM) is one standard for communication between devices and applications in device management systems. If this standard is used, the device to be managed, i.e. the mobile station 2 in FIG. 1, is equipped with a SyncML user agent 7 in the device 2 that speaks the SyncML DM language. With other device management protocols, user agent 7 is a user client for the particular device management application used in the device management system 9.

Thus, the device management system 9 has a server side device management application 10 using a device management protocol, which e.g. can be SyncML DM, which is typically used by mobile service providers. They are used for customer care purposes and to increase revenue by effective value added service management. Example use-cases involve service- and settings provisioning, device diagnostics, statistics, firmware upgrade and software upgrade.

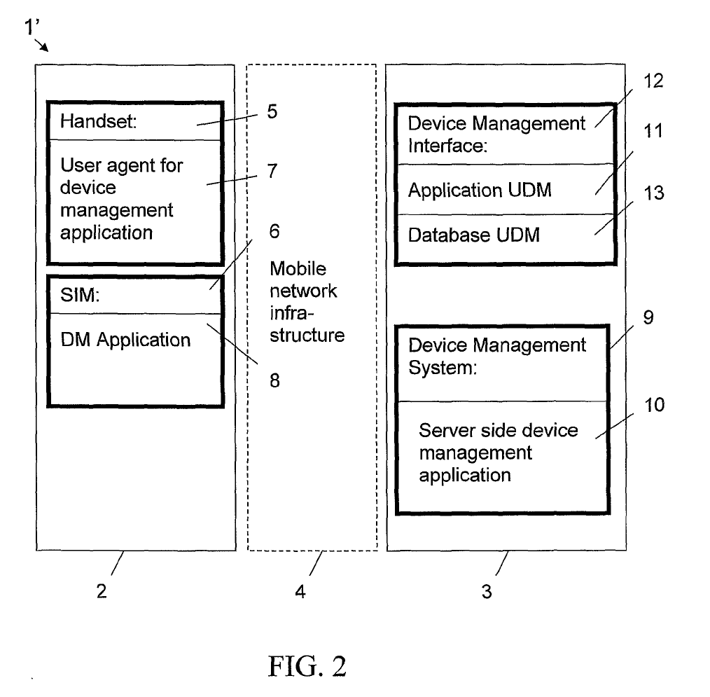

FIG. 2 is a view of an environment that includes the entities that implements the method of the invention in addition to those presented in FIG. 1. The system 1′ in FIG. 2 comprises components residing on both the mobile device 2 in FIG. 2 and on the server side 3 in FIG. 2.

A Device Management Application program (DMA), having reference number 8 in FIG. 2 and running on SIM, checks in what handset the SIM resides by reading the IMEI value from the handset. It resides as an application program on the SIM card 6 in the device 2 by transmitting information about handset changes to a server side component over the mobile network. This server side component is a Unified Device Management (UDM) check application 11 in the Unified Device Management Interface 12 on the server side 3. The DMA 8 and the UDM 11 communicate over the mobile network (GSM) 4.

The system 1′ in FIG. 2 comprises components residing on both the mobile device 2 in FIG. 2 and on the server side 3 in FIG. 2. In reality, the server side consists of several servers, one for the server side device management application and one for the DM system interface.

The UDM database has the reference number 13 in FIG. 2. It contains lists of composite device identities, which means that the UDM Identity consists of both the handset identifier and some variety of the subscription identifier. The handset identifier and the subscription identifier can each be defined by several parameters. E.g. in the GSM environment, relevant as subscription identifiers are the subscription identity, the destination address, and/or the SIM card identity [IMSI, MSIDN, ICCID]. These identities were explained in the background part. In this document the term “Subscription identifier” represents schematically all varieties of parameters for a subscription. The equipment identifier is defined by the IMEI. If using some other standard than GSM, these identities are something else. E.g. the handset identifier might e.g. be some kind of a serial number or the like, used by the terminal manufacturer.

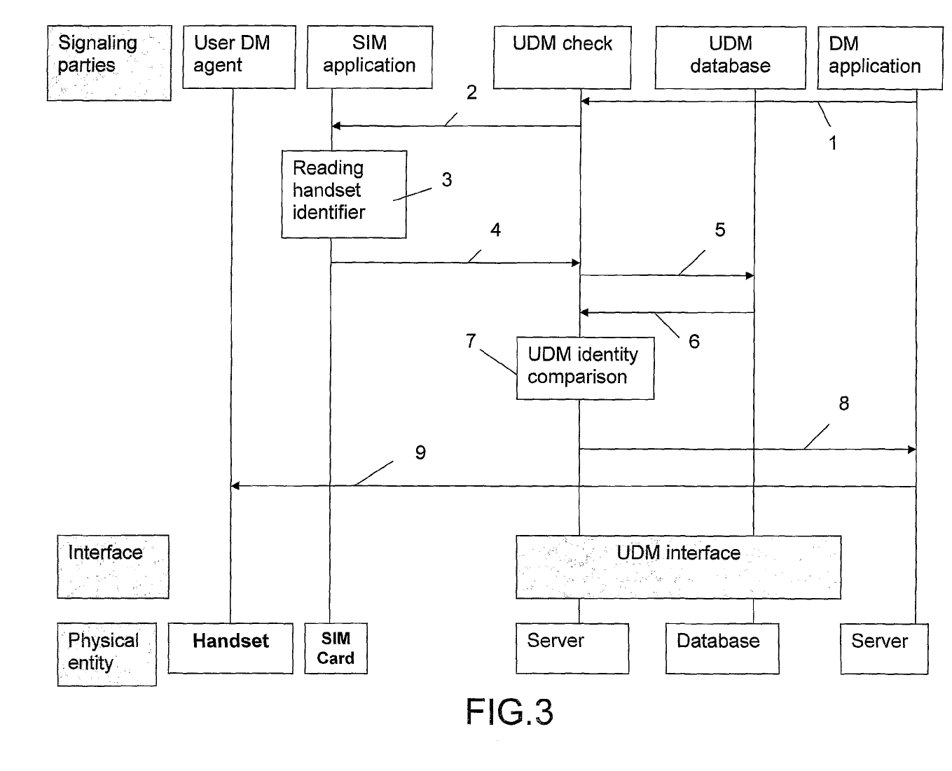

An example of an embodiment of the method of the invention is presented in form of a signal diagram in FIG. 3.

FIG. 3 shows on the lowest row, the physical entities taking part in the method of the invention. These are the handset (equipment) and the SIM card, the servers on the server side, and the UDM database described above. The signaling parties in the system of the invention comprises the client side user agent for DMA (in the handset), a SIM DMA application (in the SIM card), a server side DMA (in the server side Device Management System), a UDM check application and a UDM database (both in the UDM system interface).

It is now assumed that the user of a mobile device has changed his handset but kept his old SIM card and transferred it to the new handset.

When the server side device management application, after that this has happened, initiates a device management session via said interface in signal 1, the UDM check sends a query signal 2 to the SIM application. In step 3, the SIM application reads the handset identity and reports the information in signal 4 back to the UDM check application. The UDM check application performs a comparison to decide if the UDM identity presented in connection with FIG. 2 above is still valid. This is done by fetching the UDM identity information from the UDM database in signals 5 and 6 and performing, in step 7, a comparison of the previously stored handset identity for the particular subscription identity and the reported handset identity.

If the UDM check application considers on the basis of the comparison of said entities, e.g. IMEI and MSISDN, ICCID and/or IMSI comparison that the device to be managed is a new device, then it has discovered a new device that is now a candidate for device management. Preferably the new device identity is stored in the UDM database right away.

Said comparison result is anyway reported in signal 8 to the server side device management application. Signal 9 shows that the server side DM application now can start a device management session with the intended device.

1. A method for checking an identity of devices in a device management system in a mobile telecommunication network, comprising:
providing devices to be managed, a server-side device management application, a client-side device management application, and an interface between the device management applications, the interface having a database with lists of device identities consisting of equipment information and subscription information,
a) the server-side device management application initiating a device management session via the interface,
b) the interface sending a query to the client-side device management application,
c) the client-side device management application reading equipment information and sending the equipment information to the interface,
d) the interface comparing the read equipment information sent with previously stored equipment information for a particular subscription from which the equipment information was sent by fetching device identity information from the database and reporting a comparison result to the server-side device management application,
e) starting a device management session between the client-side device management application and the server-side device management application when, according to the comparison result, the equipment information is new.

2. The method according to claim 1 wherein the mobile network is a Global System for Mobile Communication (GSM).

3. The method according to claim 1 wherein the server-side device management application is a SyncML DM device management system.

4. The method according to claim 2 wherein the equipment information sent in step c) is an International Mobile Equipment Identity (IMEI).

5. The method according to claim 2 wherein the subscription information in step d) is a Mobile Subscriber Identity (IMSI), a Mobile Station Integrated Service Digital Network Number (MSISDN) or an Integrated Circuit Card Identity (ICCID).

6. The method according to claim 1 wherein step d) is performed by means of a device identity comprising an equipment information identifier and a subscription information identifier.

7. The method according to claim 6 wherein step d) is performed by checking the device identity in a database connected to the interface.

8. The method according to clam 1 wherein step e) comprises starting the device management session between the client-side device management application and the server-side device management application.

9. The method according to claim 1 wherein the device management session of step e) is carried out over a SyncML DM protocol.

10. A device management system in a mobile telecommunication network for providing checking identity of devices, devices to be managed, the system comprising:
is a server-side device management application in operative engagement with a client-side device management application and a database,
a component on the client-side device management application for reading an equipment identity,
an interface for checking identity of devices from a device identity repository, and
a database implementing a device identity repository, each device identity consisting of equipment information and subscription information.

11. The system according to claim 10 wherein a device to be managed is a GSM phone, the component is an application on a SIM card of the GSM phone.

12. The system according to claim 10 wherein the database that stores the device identity comprises an equipment identifier and a subscription identifier.

13. The system according to claim 10 wherein the system further comprises an equipment identifier being in a form of an International Mobile Equipment Identity (IMEI), and a subscription identifier being in a form of a Mobile Subscriber Identity (IMSI) and/or a SIM card identity being in a form of an Integrated circuit card identity (ICCID).

14. The system according to claim 10 wherein the interface is a device identity check application.
